(19) United States
(12) Patent Application Publication
(10) Pub. No.: US 2009/0136026 A1
(43) Pub. Date: May 28, 2009

(54) WATERMARK EMBEDDING USING LOOK-UP TABLES

(75) Inventors: Mehmet Utku Celik, Eindhoven (NL); Aweke Negash Lemma, Eindhoven (NL); Minne Van Der Veen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/295,650

(22) PCT Filed: Mar. 29, 2007
(86) PCT No.: PCT/IB2007/051107

§ 371 Date: Oct. 1, 2008

(30) Foreign Application Priority Data
Apr. 3, 2006 (EP) 06112166.1

(51) Int. Cl. H04L 9/32; H04L 9/00; G06F 21/24

(52) U.S. Cl. 380/42; 726/6; 726/26

(57) ABSTRACT

The invention relates to embedding a spread spectrum watermark in a data signal as well as to detection of the embedded watermark. A data signal (4) is encrypted (15) or received in the form of an encrypted data signal (9), the signal being encrypted by modifying (3) it in accordance with one or more entries of a look-up-table (2) in which an encryption table (6) is stored. The encryption is carried out by a first computing device (15) such as a server device. The watermark is actually embedded while decrypting (13) the signal. This takes place in a second computing device (16), possibly in a client device, in a similar manner The client device employs a decryption table (8), which is a modified (i.e. watermarked) version of the encryption table (6). The decryption table may generated by the server and securely communicated to the client. The data signal is decrypted in accordance with entries of a look-up-table (12). The look-up-tables (2,12) in server and client are addressed by the same sequence of pointers generated by respective index generators (1). The mismatch between encryption table (6) and decryption table (8) causes the de-signal (14) to have an embedded watermark.

### FIELD OF THE INVENTION

The invention relates to a method and device for embedding a watermark in a data signal, and in particular to embedding a watermark in the signal using look-up tables. Moreover, the invention relates to methods and devices for detecting a watermark in a data signal, as well as to computer readable code for implementing the methods of the invention.

### BACKGROUND OF THE INVENTION

Digital watermarking has proven an effective deterrent against illegal distribution of copyrighted material in digital form, for instance over computer networks, via electronic content distribution (ECD) applications or via hand-to-hand public distribution.

Forensic tracking watermarks are embedded in multimedia content to trace distributed copies of the content. Embedding watermarks in multimedia content is a complex operation in terms of computer power. Large-scale deployment of forensic tracking watermarks requires an efficient, scalable system of embedding watermarks and distributing the watermarked contents. Client-side embedding solves the scalability problem, since the server's processing load is distributed to the clients. Moreover, instead of sending distinct watermarked copies with point-to-point connections, a common unmarked copy can be broadcast—or multicast, cached at intermediate nodes, etc.

In the article “Chameleon—a new kind of stream cipher” by R. J. Anderson and C. Manifavas published in FSE'97: Proc. of the 4th Int. Workshop on Fast Software Encryption, Springer-Verlag 1997, pp. 107-113; a method is disclosed where a pseudo-random number generator operated in output-feedback mode is used to generate a keystream, a plaintext is enciphered by a process where four words selected from the keystream are EXOR-ed together and subsequently EXOR-ed with the plaintext.

### SUMMARY OF THE INVENTION

The inventors of the present invention have appreciated that an improved means of handling watermarking of digital content is of benefit, and has in consequence devised the present invention. The inventors have had the insight that the method of the prior art deals with bit modifications of the data stream in the form of exclusive-or operations, and is thereby fragile to removal of the watermark. The present invention seeks to provide an improved means for copyright protection, and preferably, the invention alleviates, mitigates or eliminates one or more disadvantages of the prior art, singly or in any combination.

According to a first aspect of the present invention there is provided, a method for embedding a spread spectrum watermark in a data signal, the method comprising:

receiving an encrypted data signal, the data signal being encrypted by modifying the data signal in accordance with one or more entries of an encryption table; receiving a decryption table, the decryption table being a modified version of the encryption table; and

decrypting the data signal in accordance with entries of the decryption table thereby embedding a watermark in the data signal.

The method according to the invention embeds a spread spectrum watermark. The encrypted, watermarked or generally modified bits are spread or distributed over multiple bits. It is more robust than the prior art watermark, and can better be detected. The method includes a first step where the unmarked data signal is modified in accordance with one or more entries of an encryption table, and a second step where the encrypted signal is decrypted and watermarked in a single process. The decryption is based on a decryption table being a modified version of the encryption table. The modification is preferably obtained by applying, e.g. adding or multiplying, a watermark table to the encryption table. The encryption table may be randomly generated.

The data signal may be a signal of, or a signal containing or including, audio, video, images, multimedia software, multidimensional graphical models, software structures, etc. singly or any combination.

The data signal may be represented by a series of symbols, where a symbol of the data signal is to be understood as any representation of the data signal, such as a segments of the bit stream, a base-band signal, a DCT coefficient of the signal in the transform domain, etc. In an example, the present invention may be applied to each pixel value or a subset of pixel values in an image or video sequence, in this case the symbol of the signal may be the pixel values. In another example, the present invention may be applied to transform coefficients of the data signal, in this case the symbol of the signal may be the transform coefficients. For example for audio signals the coefficient may be coefficient representing the amplitude, pitch or the like of the signal. The coefficients may also be coefficient of a specific encoding of the signal, such as MDCT coefficients, linear prediction coefficients, Fourier coefficient, etc.

The invention according to the first aspect is particularly but not exclusively advantageous for a number of reasons. Spread spectrum watermarking is typically resistant to tampering, degradation and common signal processing operations, contrary to watermarking by means of bit-modifications, where at least some types of modifications may be removed by setting the modified bits to random values and thereby removing the watermark. Moreover, in order to be able to detect the embedded watermark in accordance with the present invention, the original unmarked data signal is not required. Only the watermark, typically in the form of a watermark table, and the corresponding entries of the decryption table may be needed. Moreover, the watermark may be embedded in accordance with a perceptual mask, dictating the strength of the watermark at specific locations in the signal.

The optional feature as defined in claim 2 is advantageous since the size of the input key may be considerably smaller than the size of the encryption, decryption or watermark table. For example compared to a method using one-time pads (OTP), the key size is significantly reduced.

The optional features as defined in claim 3 describe an advantageous implementation of the method where the data signal is encrypted at a first computing system, such as a secure system, and wherein the data signal is decrypted and the watermark embedded at a second computing system, the second system not necessarily being a secure system. The decryption table may be generated at the first computing system or accessed by the first computing system, e.g. at another computing system communicatively connected to the first computing system.

Claim 4 describes advantageous embodiments of embedding a watermark. It is an advantage of the present invention, that a watermark may be embedded both additively and multiplicatively in the signal.

The optional feature as defined in claim 5 is advantageous since by basing the watermark table on a modified version of a reference watermark table a payload may be inserted.

In an embodiment a series of decryption tables are generated based on a series of watermark tables, the series of watermark tables may be modified versions of a reference watermark table. The modified version may be obtained by circularly shifting the reference watermark table, the shift representing a payload.

According to a second aspect of the present invention there is provided a method of detecting a watermark in a data signal, the method comprising:

receiving a data signal possibly including a spread spectrum watermark, the possible watermark being embedded in accordance with entries of a decryption table;

generating a sequence of indices corresponding to the entries of a watermark table, and constructing the watermark therefrom;

detecting the presence of the watermark in the data signal.

The method according to the second aspect of the invention is provided in accordance with detecting a watermark embedded by the method of the first aspect of the invention.

The detection of the watermark may be obtained from a correlation of the data signal with the watermark. Optionally may an estimated watermark be derived from the data signal and the presence of the watermark may be detected in the estimated watermark. The watermark to be detected may be generated from a watermark table and the sequence of entries.

According to a third aspect of the present invention there is provided a method of detecting a watermark in a data signal, the method comprising:

receiving a data signal possibly including a spread spectrum watermark, the possible watermark being embedded in accordance with entries of a decryption table;

generating a sequence of indices corresponding to the entries of the decryption table;

accumulating segments of the data signal in an accumulation table at positions corresponding to the sequence of indices, thereby generating an accumulation table of the data signal;

detecting the presence of the watermark in the accumulation table.

The method according to the third aspect of the invention is provided in accordance with detecting a watermark embedded by the method of the first aspect of the invention.

The method according to the third aspect of the invention is advantageous, since the accumulation table may be much shorter that the signal, thereby providing a faster detection process. In a situation where a large number of possible watermarks is to be searched in a given data signal, it is important that the detection process is fast.

The detection of the watermark may be obtained from a correlation of the accumulation table with the watermark table. Optionally may an estimated watermark be derived from the data signal, and the presence of the watermark may be detected in the estimated watermark. The accumulation table may be constructed from the estimated watermark.

In an embodiment a series of decryption tables generated based on a series of watermark tables, the series of watermark tables being modified versions of a reference watermark table. The modified version may be obtained by circularly shifting the reference watermark table. The detection of the watermark may be obtained by a correlation of the accumulation table with the series of watermark tables, or from a correlation of the accumulation table with the reference table.

In a fourth aspect of the invention is provided a watermark embedder for embedding a spread spectrum watermark in a data signal.

In fifth and sixth aspects of the invention are watermark detectors for detecting the presence of a watermark possibly being embedded in a data signal.

In seventh, eight and ninth aspects of the invention are provided computer readable code for implementing the methods of the first, second and third aspects.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 schematically illustrates a scheme for embedding a watermark in a data signal;

FIG. 2 illustrates an embodiment of the encryption process;

FIG. 3 illustrates an embodiment of the decryption and watermarking process;

FIG. 4 schematically illustrates a scheme for detecting a watermark in a data signal;

FIG. 5 illustrates an embodiment of the detection procedure of FIG. 4;

FIG. 6 schematically illustrates another scheme for detecting a watermark in a data signal; and

FIG. 7 illustrates an embodiment of the detecting procedure of FIG. 6.

### DESCRIPTION OF EMBODIMENTS

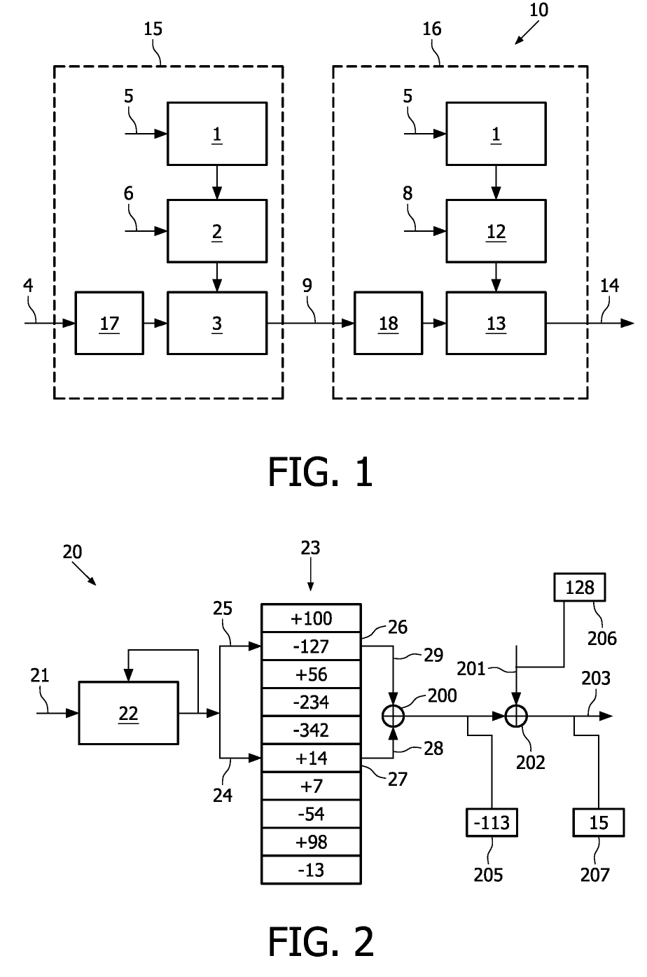

FIG. 1 schematically, in accordance with an embodiment of the invention, illustrates a scheme or process 10 for embedding a watermark in a data signal 4. FIG. 1 illustrates the embedding process in connection with a first computing device 15, such as a server device, and a second computing device 16, such as a client or user device. In this embodiment, the watermark embedder is implemented so that a first part is present on the first computing device 15, whereas a second part is present on the second computing device 16. The unmarked data signal 4, such as a signal with video or audio content is received or accessed at a signal unit 17 at the server 15.

The embedding process is conducted in two steps or parts, in a first part the signal is encrypted, this part is typically performed at the server 15, and in the second part, the signal is decrypted and the watermark is embedded, this part is typically performed at the client device 16.

The input of the encryption process comprises inputting an input key 5 into a secure index generator 1, the secure index generator being operable to generate a unique series of indices from the input key. Each index of the index generator is pointing to an entry in a look-up table 6. The look-up table is received by, accessed by or generated at the server by means of a table unit 2. The data is encrypted at an encryption unit 3 by modifying the data signal in accordance with the entries of the encryption table. The encrypted signal 9 is then distributed to a user. The encrypted signal 9 is receiving or accessing at signal unit 18 for receiving the encrypted data signal, the user-device, i.e. the client device, also receives or accesses the input key 5. Given the input key, the secure index generator 1 is capable of generating the same series of indices as used for encrypting the data signal. Moreover, the client device receives or accesses a decryption table 8 at an encryption table unit 12, the decryption table being a watermarked version of the encryption table. The encrypted signal is decrypted at an embedding unit 13 by modifying the encrypted data signal in accordance with the corresponding entries of the decryption table. Because the decryption table is a watermarked version of the encryption table, the decrypted signal 14 is a watermarked version of the original input signal. The input key and the decryption table are distributed to the client via a secure communication channel, either separately or collectively. The input key and the decryption table are normally sent separate from the encrypted data signal. The signal may be distributed via a computer network, via an electronic content distribution (ECD) application, via a record carrier, such as a recordable or ROM optical record carrier or semiconductor or magnetic based carrier, etc. A user of the signal may then render or playback the signal on a device adapted for reading the data signal, such as on a CD-player, a DVD-player, a computer, a portable playback device, a game console, etc.

The process of the present invention thus renders it possible to embed and distribute watermarked content in a secure, efficient and scalable manner. Handling of unmarked and unencrypted data may be done at a trusted site, e.g. by a trusted server device 15. Unmarked, but encrypted data is distributed to a potentially untrusted client 16, which locally performs the decryption and the watermarking of the data signal in a process where neither the unmarked content nor the watermark signal is exposed to the client. The user only gains accesses to the input key and the decryption table.

FIG. 2 illustrates an embodiment of the encryption process 20 in accordance with the embedding scheme of FIG. 1.

The watermarking is based on an index generator 22 and an encryption table 23. The index generator 22 may be a secure pseudo-random number generator, such as a stream-cipher operating in output-feedback mode (OFB). A stream-cipher in OFB-mode is capable of generating a series of indices 24, 25 from a short term input key 21. The size of the input key may be 64 or 128 bits. The encryption look-up table (LUT) 23 is a long-term table, or key, comprising a large number of entries. The encryption LUT is also referred to as E. The LUT size may be in the range between 128 KB to 128 MB. A size of 1 MB may be a typical size, the specific size of the LUT may be determined in a trade-off between security and size.

In the illustrated embodiment, the process is exemplified with integer entries of the look-up table and an integer value representation of the data signal, however it is to be understood that the process is not limited to this. The data signal is represented as a series of symbols. The symbol of the data signal is to be understood as any representation of the data signal, such a segments of the bit stream or the DCT coefficient, Cₙ, of the signal in the transform domain, here represented by integer values.

The look-up table 23 may be randomly generated at the server. In FIG. 2 a number of integers are illustrated at different entry positions, one entry denoted 26 is the negative integer -127, another entry denoted 27 is the positive integer +14. The type of entry reflects the signal representation into which the watermark is embedded. If for example the watermark is embedded into luminance pixel values of an image, the entries would range from 0 to 255. For other representations of the data signal, other entry types or values are used. For example, DCT coefficients may be represented by real values.

A number of pointers or indexes 24, 25 are generated for each symbol of the data signal, here exemplified by two, however, any number such as 3, 4, 5, 10 or even more pointers may be applied.

The LUT entries indexed by each pointer are extracted 28, 29 and added together 200, e.g. E(t₂ₙ)=−127 and E(t₂ₙ₊₁)=+14 are extracted and added resulting in an encryption key for the given symbol of the data signal, here the integer number −113 as denoted by 205. The encryption key 205 is subsequently combined (added) 202 with the symbol of the data signal, here exemplified with the number +128 as denoted by 206, resulting in an encrypted data symbol 203, in this case being +15 as denoted by 207. In terms of transform domain coefficient, a modified, i.e. encrypted coefficient may be expressed as:

C′ₙ=Cₙ+E(t₂ₙ)+E(t₂ₙ₊₁).

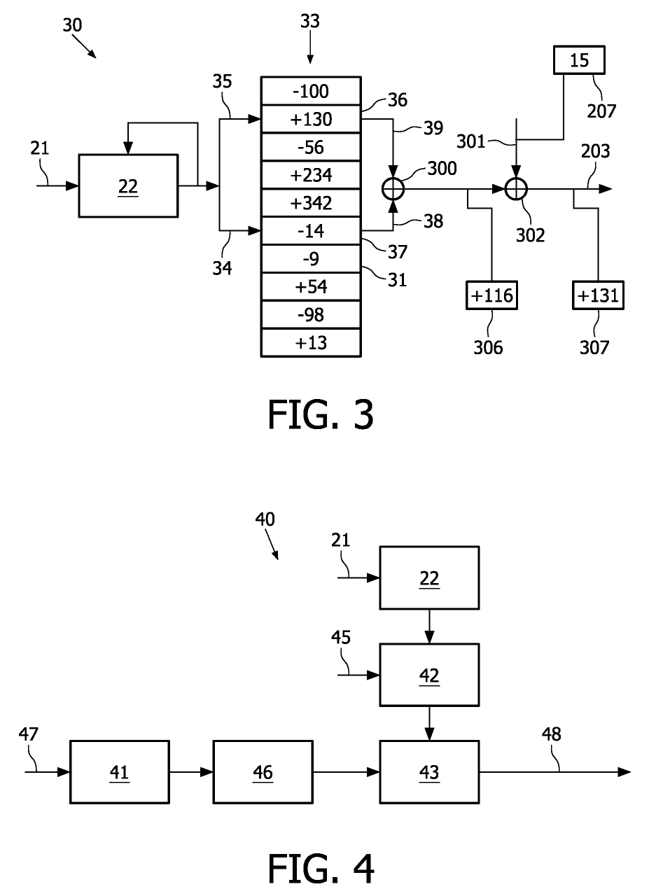

FIG. 3 illustrates an embodiment of the decryption and watermarking process 30 in accordance with the decryption and watermarking scheme of FIG. 1.

From the LUT E, the server constructs the long-term decryption table 33 Dₖ. The decryption table being user-specific, k referring to a user-specific index, e.g.: Dₖ=−(E+Wₖ). The user may be a specific end user, a group of end-users, or the like. The user-specific watermark is referred to as Wₖ. The entries of Wₖ may be random variables with a variance much less than E. The watermark is also in the form of a LUT typically of the same size as E. By indexing the decryption table (i.e. the watermark table) forensic tracking is possible, since a given watermark may be linked to the intended user.

The decryption and watermarking is performed at the client side 16, by generating indices and modifying the data with the LUT corresponding to these indices.

As in connection with the encryption, indices are generated by an index generator 22 (stream-cipher operating in the OFB-mode). The short term input key 21 is used for generating the corresponding sequence or series of pointers 34,35 tₙ, as in connection with the encryption of the data.

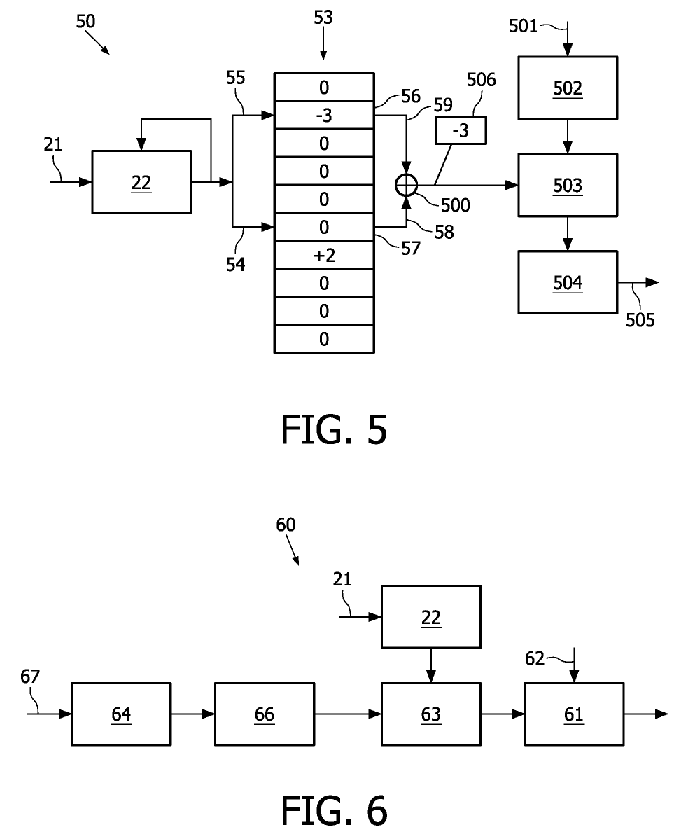

The watermarking of the encryption table slightly alters entries of the table entries. In this embodiment where Dₖ=−(E+Wₖ), the entry denoted 36 has been altered by subtracting 3 giving a new entry of +130, whereas the entry denoted 37 has not been altered, since the entry in the watermark table is zero, instead the entry denoted 31 has been altered. The corresponding watermark LUT 53 is illustrated in FIG. 5.

As in connection with the encryption, the decryption LUT entries of each pointer are extracted 38, 39 and added together 300, e.g. E(t₂ₙ)=+130 and E(t₂ₙ₊₁)=−14 are extracted and added resulting in a decryption key, here the integer number +116 as denoted by 306. The decryption key is subsequently combined 302 with the symbol of the encrypted data signal, here exemplified with the number +15 as denoted by 207 (the resulting encrypted symbol of FIG. 2), resulting in a decrypted, but watermarked, data symbol, in this case being +131 as denoted by 307. In terms of transform domain coefficient, a modified, i.e. decrypted and watermarked coefficient may be expressed as:

C_{W,n}=C′ₙ+D(t₂ₙ)+D(t₂ₙ₊₁).

FIG. 4 schematically illustrates an embodiment of a scheme 40 for detecting a watermark in a data signal in accordance with the present invention, the scheme may be implemented in a watermark detector. Watermark detection may be performed on data possibly including a watermark, e.g. on suspect data, the detection process may be performed at a secure server site having access to the watermark to be detected.

The data signal 47 possibly including a watermark is received at a signal unit 41, and optionally the watermark is estimated at an estimator unit 46 from the received data signal. The watermark estimation may e.g. be the application of a high-pass filter which may enhance the watermark signal, other types of watermark estimation method may be used. Detection of the watermark may, however, also be conducted on the data signal in the received form.

The input key 21 used for generating the sequence of entries for the watermark possibly in the data signal is inputted into the secure index generator 22, and the relevant entries of a watermark LUT 45, is extracted at a table unit 42 and the watermark is generated therefrom. Subsequently the presence 48 of the generated watermark is detected at a detector unit 43 in the signal by comparing the data signal or estimated watermark with the watermark deduced from the watermark LUT.

FIG. 5 illustrates an embodiment of the detecting procedure 50 in accordance with the detection scheme of FIG. 4.

As in connection with the encryption and decryption, indices 54, 55 are generated by an index generator 21, 22 (a stream-cipher operating in the OFB-mode). The indices are used together with the watermark LUT 53 to reconstruct the watermark sequence.

The watermark LUT is the difference LUT between the encryption and the decryption LUT. In the given example all but a few of the entries are zero, however more entries, most entries or even all entries may include finite (typically small) values. The LUT entries of each pointer is extracted 58, 59 and added together 500 to construct the watermark value, e.g. Wₖ(t₂ₙ)=−3 as denoted by 56 and Wₖ(t₂ₙ₊₁)=0 as denoted by 57 are extracted 58, 59 and added 500 resulting in the watermark value, here the integer number −3 as denoted by 506. From the investigated data signal 501, the watermark is optionally estimated 502 (e.g. by means of a high-pass transform of the data signal) and the estimated watermark value is correlated 503 with the watermark values deduced from the watermark LUT 53. The correlation result is compared to a threshold value 504 so as to determine 505 whether or not the investigated (or suspected) data did in fact contain the watermark in question.

FIG. 6 schematically illustrates another embodiment of a scheme 60 for detecting a watermark in a data signal in accordance with the present invention, the scheme may be implemented in a watermark detector.

The data signal 67 possibly including a watermark is received at a signal unit 64 and optionally the watermark is estimated from the received data signal at an estimator unit 66. The input key 21 and the index generator 22 are used for generating and extracting the relevant entries as before. However, in the present embodiment, the segments, or symbols, of the data signal corresponding to the sequence of indices are accumulated in an accumulation LUT by an accumulation unit 63. The watermark 62 is detected by a detector unit 61 in the signal by correlating the accumulation LUT with the watermark LUT. Thus, in this embodiment the received data signal is rearranged in an accumulation table so that the relevant segments of the data signal are arranged in accordance with the entries generated by the secure index generator 22.

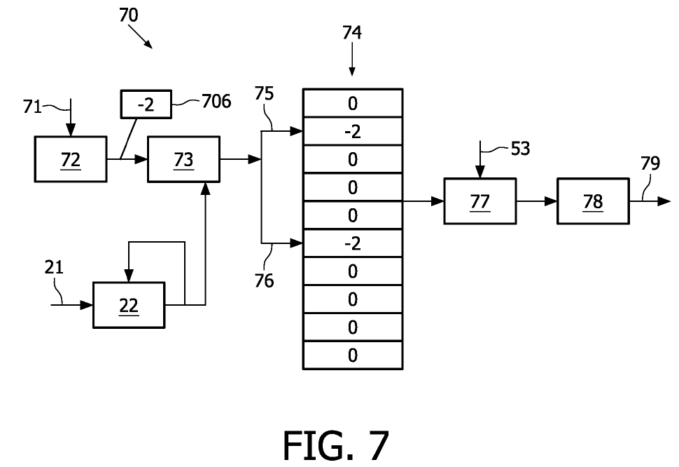

FIG. 7 illustrates an embodiment of the detecting procedure 70 in accordance with the detection scheme of FIG. 6.

As in connection with the encryption and decryption, indices are generated by an index generator 22 and the input key 21. The data is received 71 and the watermark is optionally estimated 72 therefrom. The symbol of the data signal is extracted, here exemplified by the integer −2 as denoted by 706. The symbols of the data signal are accumulated 73 in an accumulation table 74 in accordance with the series of indices as generated by the index generator. The accumulation table is initially empty. In the situation that the entries of the symbol of the data signal correspond to t₂ₙ and t₂ₙ₊₁, the symbol is inserted into the accumulation table 74 at these positions 75, 76. Once the entire accumulation table has been constructed, the accumulation table is correlated 77 with the watermark LUT 53 of the watermark. The correlation result is compared to a threshold value 78 so as to determine 79 whether or not the data signal did in fact contain the watermark in question.

In connection with the Figures the embodiments applying additive watermarking have been illustrated. The present invention may however also be applied in connection with multiplicative watermarking. In this case, addition and subtraction are replaced by multiplication and division.

In embodiments of the present invention different watermarks can be embedded into the same data signal by using different decryption tables on the encrypted signal. In that case, the decryption tables may be based on corresponding, but different, watermark tables. Moreover, these watermark tables may be derived from a common reference table. In one embodiment, the watermark tables are generated by circularly shifting the reference table. In that case, the detection process may be performed by a computation of the correlation between the accumulation table and all different watermark tables, such a correlation computation may in accordance with the present invention be performed in an efficient manner. The efficient computation involves correlating the accumulation table with the reference table. This process may be performed in the frequency domain by determining a correlation vector, C, as:

C=IFFT(FFT(AccumulationTable)*Conj(FFT(ReferenceTable)),

where FFT(.) refers to the fast Fourier transform, IFFT(.) to the inverse fast Fourier transform, and Conj(.) to the conjugate of a complex signal. The resulting correlation vector C corresponds to the correlation values for all possible shifts of the reference table. As a result, correlations with all different watermark tables, which are shifted versions of the reference table, can be performed in a single step, saving processing time as opposed to correlating each watermark table individually with the accumulation table.

In other embodiments it may be necessary to correlate the data signal with the series of watermarks, and possible it may even be necessary to correlate the data signal with a number of reference watermarks, each reference watermark being represented by a series of watermark samples. In the Figures only the situation of a single instant of a watermark possible being, or being based on, a reference watermark is illustrated, it is however to be understood that the illustrated embodiments may be generalized to embed and detect watermarks based on a reference watermark.

In preferred embodiments of the invention, the watermarking method and apparatus also comprise perceptual masking. Perceptual masking refers to local and/or global adjustments to the watermark strength in accordance with the human audio-visual perception. Exploiting the human perception characteristics renders it possible to embed a stronger watermark signal to the digital content, thus improving the robustness against malicious attacks, without any adverse effects on the perceptual quality of the watermarked digital object. The process of perceptual masking typically involves applying a perceptual mask filter h(.) to the watermark w. The mask is preferably computed from the digital content in advance of the actual watermark embedding process. If such advance computing is not possible or feasible, a generic mask filter may be used.

In the watermarking method according to the invention, the mask filter h(.) can not be applied to the watermark wₖ, because the watermark as such is not accessible. Instead, the filter h(.) is applied to the encryption key (i.e. the sequence of entries of encryption table 23 as added by adder 200 in FIG. 2) and to the decryption key (i.e. the sequence of added entries of decryption table 33 in FIG. 3). The perceptual masking operation can be illustrated as follows:

Using the notation E(t) for the encryption key, the encrypted digital object, e(x), can be written as:

e(x)=x+h(E(t))

The decryption key Dk(t) differs from E(t) by the client-specific watermark wk:

Dₖ(t)=E(t)−wₖ

The watermarked signal is obtained by decryption of e(x) using Dk(t):

x_{w}=e(x)−h(Dₖ(t))

Using the required linear property of the perceptual mask filter, this yields:

x_{w}=(x+h(E(t)))−(h(E(t)−h(wₖ))=x+h(wₖ)

In summary, the invention relates to embedding a spread spectrum watermark in a data signal as well as to detection of the embedded watermark. A data signal is encrypted or received in the form of an encrypted data signal, the signal being encrypted by modifying it in accordance with one or more entries of a look-up-table in which an encryption table is stored. The encryption is carried out by a first computing device such as a server device. The watermark is actually embedded while decrypting the signal. This takes place in a second computing device, possibly in a client device, in a similar manner. The client device employs a decryption table, which is a modified (i.e. watermarked) version of the encryption table. The decryption table may generated by the server and securely communicated to the client. The data signal is decrypted in accordance with entries of a look-up-table. The look-up-tables in server and client are addressed by the same sequence of pointers generated by respective index generators. The mismatch between encryption table and decryption table causes the decrypted signal to have an embedded watermark.

The invention can be implemented in any suitable form including hardware, software, firmware or any combination of these. The invention or some features of the invention can be implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A method for embedding a spread spectrum watermark in a data signal, the method comprising:
receiving an encrypted data signal, the data signal being encrypted by modifying the data signal in accordance with one or more entries of an encryption table;
receiving a decryption table, the decryption table being a modified version of the encryption table; and
decrypting the data signal in accordance with entries of the decryption table such that a watermark is embedded in the data signal.

2. The method according to claim 1, wherein a sequence of indices pointing to the entries of the encryption table or decryption table is determined based on a secure index generator operable to generate a unique series of indices from an input key.

3. The method according to claim 1, wherein the data signal is encrypted at a first computing system, and wherein the data signal is decrypted and the watermark embedded at a second computing system.

4. The method according to claim 1, wherein the modification is an additive or a multiplicative modification.

5. The method according to claim 1, wherein the decryption table is generated based on a watermark table, the watermark table being a modified version of a reference table.

6. A method of detecting a watermark in a data signal, the method comprising:
receiving a data signal including a spread spectrum watermark, the watermark being embedded in accordance with entries of a decryption table;
generating a sequence of indices corresponding to the entries of a watermark table, and constructing the watermark therefrom; and
detecting the presence of the watermark in the data signal.

7. The method according to claim 6, wherein the detection of the watermark is a correlation of the data signal with the watermark.

8. The method according to claim 6, wherein an estimated watermark is derived from the data signal, and wherein the presence of the watermark is detected in the estimated watermark.

9. A method of detecting a watermark in a data signal, the method comprising:
receiving a data signal including a spread spectrum watermark, the watermark being embedded in accordance with entries of a decryption table;
generating a sequence of indices corresponding to the entries of the decryption table;
accumulating segments of the data signal in an accumulation table at positions corresponding to the sequence of indices, thereby generating an accumulation table of the data signal; and
detecting the presence of the watermark in the accumulation table.

10. The method according to claim 9, wherein the detection of the watermark of the data signal is a correlation of the accumulation table with a watermark table.

11. The method according to claim 9, wherein an estimated watermark is derived from the data signal, and wherein the accumulation table is constructed from the estimated watermark.

12. The method according to claim 9, wherein the detection of the watermark is a correlation of the accumulation table with a reference table, the reference table being a table from which a series of watermark tables has been derived.

13. A watermark embedder unit for embedding a spread spectrum watermark in a data signal, the watermark embedder unit comprising:
a signal unit for receiving an encrypted data signal, the data signal being encrypted by modifying the data signal in accordance with one or more entries of an encryption table;
a table unit for receiving a decryption table, the decryption table being a modified version of the encryption table; and
an embedding unit for decrypting the data signal in accordance with entries of the decryption table thereby embedding a watermark in the data signal.

14. Watermark detector comprising:
a signal unit for receiving a data signal including a spread spectrum watermark, the watermark being embedded in accordance with entries of a decryption table;
an index generator for generating a sequence of indices corresponding to the entries of a watermark table, and constructing the watermark therefrom; and
a detector unit for detecting the presence of the watermark in the data signal.

15. Watermark detector comprising:
a signal unit for receiving a data signal including a spread spectrum watermark, the watermark being embedded in accordance with entries of a decryption table;
an index generator for generating a sequence of indices corresponding to the entries of the decryption table;
an accumulation unit for accumulating segments of the data signal in an accumulation table at positions corresponding to the sequence of indices, thereby generating an accumulation table of the data signal; and
a detector unit for detecting the presence of the watermark in the accumulation table.

16. (canceled)

17. (canceled)

18. A storage medium having a computer readable code embedded therein for embedding a spread spectrum watermark in a data signal by a) receiving an encrypted data signal, the data signal being encrypted by modifying the data signal in accordance with one or more entries of an encryption table; b) receiving a decryption table, the decryption table being a modified version of the encryption table; and c) decrypting the data signal in accordance with entries of the decryption table such that a watermark is embedded in the data signal.

19. (canceled)

20. (canceled)
